(19) United States
(12) Patent Application Publication
(10) Pub. No.: US 2023/0278562 A1
(43) Pub. Date: Sep. 7, 2023

(54) METHOD TO ARBITRATE MULTIPLE AUTOMATIC LANE CHANGE REQUESTS IN PROXIMITY TO ROUTE SPLITS

(71) Applicant: GM GLOBAL TECHNOLOGY OPERATIONS LLC, Detroit, MI (US)

(72) Inventors: Jeffrey S. Parks, Ann Arbor, MI (US); Paul A Adam, Milford, MI (US); Braden J. Swantick, Canton, MI (US)

(73) Assignee: GM GLOBAL TECHNOLOGY OPERATIONS LLC, Detroit, MI (US)

(21) Appl. No.: 17/652,972

(22) Filed: Mar. 1, 2022

(51) Int. Cl. B60W 30/18; B60W 60/00

(52) U.S. Cl. CPC B60W 30/18163; B60W 60/001; B60W 2552/10

(57) ABSTRACT

Methods and systems are provided for automatically controlling lane changes for a vehicle. In one exemplary embodiment: vehicle sensors are configured to provide sensor data pertaining to operation of the vehicle and surroundings of the vehicle along a roadway in which the vehicle is travelling; and a processor configured to at least facilitate: receiving, from a plurality of vehicle assessors, a plurality of respective requests with respect to one or more automated lane change maneuvers for the vehicle; and selectively implementing the one or more automated lane change maneuvers for the vehicle based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

### TECHNICAL FIELD

The present disclosure generally relates to vehicles, and more particularly relates to systems and methods for controlling lane change requests for vehicles.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

In certain circumstances it may be desirable for improved arbitration of multiple lane change request for vehicles, including autonomous vehicles.

Accordingly, it is desirable to provide systems and methods for arbitrating lane change requests for vehicles, including autonomous vehicles. Furthermore, other desirable features and characteristics of the present disclosure will become apparent from the subsequent detailed description and the appended claims, taken in conjunction with the accompanying drawings and the foregoing technical field and background.

### SUMMARY

In an exemplary embodiment, a method is provided for automatically controlling lane changes for a vehicle, the method including: obtaining sensor data via one or more vehicle sensors during operation of the vehicle, the sensor data pertaining to operation of the vehicle and surroundings of the vehicle along a roadway in which the vehicle is travelling; receiving, from a plurality of vehicle assessors, a plurality of respective requests with respect to one or more automated lane change maneuvers for the vehicle; and selectively implementing the one or more automated lane change maneuvers for the vehicle, in accordance with instructions provided by a processor of the vehicle, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

Also in an exemplary embodiment, the one or more automated lane change maneuvers include a passing of one or more target vehicles along the roadway, and the plurality of vehicle assessors includes an overtaking condition assessor configured to make one or more requests pertaining to passing of the one or more target vehicles along the roadway.

Also in an exemplary embodiment, the plurality of vehicle assessors further includes a route following condition assessor configured to make one or more additional requests pertaining to following a route of travel for the vehicle.

Also in an exemplary embodiment, the lane arbitration scores are based upon a shortest distance required for each of the one or more automated lane change maneuvers.

Also in an exemplary embodiment, the lane arbitration scores include positive and negative arbitration scores for the plurality of lanes, wherein a positive arbitration score for a particular lane of the plurality of lanes indicates that turning into the particular lane is optimal, and wherein a negative arbitration score for the particular lane indicates that turning into the particular lane is not optimal.

Also in an exemplary embodiment, the positive and negative arbitration scores are updated by the processor based on highest positive and negative priorities for the plurality of lanes, based upon comparison of required distances for the plurality of lanes with a predetermined threshold.

Also in an exemplary embodiment, the steps of the method are implemented in connection with an autonomous vehicle.

In another exemplary embodiment, a system for automatically controlling lane changes for a vehicle is provided that includes: one or more vehicle sensors configured to provide sensor data during operation of the vehicle, the sensor data pertaining to operation of the vehicle and surroundings of the vehicle along a roadway in which the vehicle is travelling; and a processor coupled to the one or more vehicle sensors and configured to at least facilitate: receiving, from a plurality of vehicle assessors, a plurality of respective requests with respect to one or more automated lane change maneuvers for the vehicle; and selectively implementing the one or more automated lane change maneuvers for the vehicle, in accordance with instructions provided by the processor, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

Also in an exemplary embodiment, the one or more automated lane change maneuvers include a passing of one or more target vehicles along the roadway, and the plurality of vehicle assessors includes an overtaking condition assessor configured to make one or more requests pertaining to passing of the one or more target vehicles along the roadway.

Also in an exemplary embodiment, the plurality of vehicle assessors further includes a route following condition assessor configured to make one or more additional requests pertaining to following a route of travel for the vehicle.

Also in an exemplary embodiment, the lane arbitration scores are based upon a shortest distance required for each of the one or more automated lane change maneuvers.

Also in an exemplary embodiment, the lane arbitration scores include positive and negative arbitration scores for the plurality of lanes, wherein a positive arbitration score for a particular lane of the plurality of lanes indicates that turning into the particular lane is optimal, and wherein a negative arbitration score for the particular lane indicates that turning into the particular lane is not optimal.

Also in an exemplary embodiment, the positive and negative arbitration scores are updated by the processor based on highest positive and negative priorities for the plurality of lanes, based upon comparison of required distances for the plurality of lanes with a predetermined threshold.

In another exemplary embodiment, a vehicle is provided that includes: one or more vehicle sensors configured to provide sensor data during operation of the vehicle, the sensor data pertaining to operation of the vehicle and surroundings of the vehicle along a roadway in which the vehicle is travelling; a control system including a plurality of vehicle assessors; and a processor coupled to the one or more vehicle sensors and to the plurality of vehicle assessors and configured to at least facilitate: receiving, from the plurality of vehicle assessors, a plurality of respective requests with respect to one or more automated lane change maneuvers for the vehicle; and selectively implementing the one or more automated lane change maneuvers for the vehicle, in accordance with instructions provided by the processor, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

Also in an exemplary embodiment, the one or more automated lane change maneuvers include a passing of one or more target vehicles along the roadway, and the plurality of vehicle assessors includes an overtaking condition assessor configured to make one or more requests pertaining to passing of the one or more target vehicles along the roadway.

Also in an exemplary embodiment, the plurality of vehicle assessors further includes a route following condition assessor configured to make one or more additional requests pertaining to following a route of travel for the vehicle.

Also in an exemplary embodiment, the lane arbitration scores are based upon a shortest distance required for each of the one or more automated lane change maneuvers.

Also in an exemplary embodiment, the lane arbitration scores include positive and negative arbitration scores for the plurality of lanes, wherein a positive arbitration score for a particular lane indicates that turning into the particular lane is optimal, and wherein a negative arbitration score for the particular lane indicates that turning into the particular lane is not optimal.

Also in an exemplary embodiment, the positive and negative arbitration scores are updated by the processor based on highest positive and negative priorities for the plurality of lanes, based upon comparison of required distances for the lanes with a predetermined threshold.

Also in an exemplary embodiment, the vehicle includes an autonomous vehicle.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a lane change control system for arbitrating lane change requests, in accordance with various embodiments;

FIG. 2 is functional block diagram illustrating an autonomous driving system (ADS) having a lane change control system associated with the vehicle of FIG. 1, in accordance with various embodiments;

FIG. 3 is a functional block diagram illustrating functionality of the lane change control system of FIGS. 1 and 2, in accordance with various embodiments;

FIGS. 4 and 5 depict the vehicle of FIG. 1 in connection with a roadway with traffic impacting potential lane changes for the vehicle, in accordance with various embodiments; and

FIGS. 6A and 6B is a flowchart of a lane change control process in which lane change requests are arbitrated by a lane change control system of a vehicle, and that can be implemented in connection with the vehicle, components, and environments of FIGS. 2-5, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

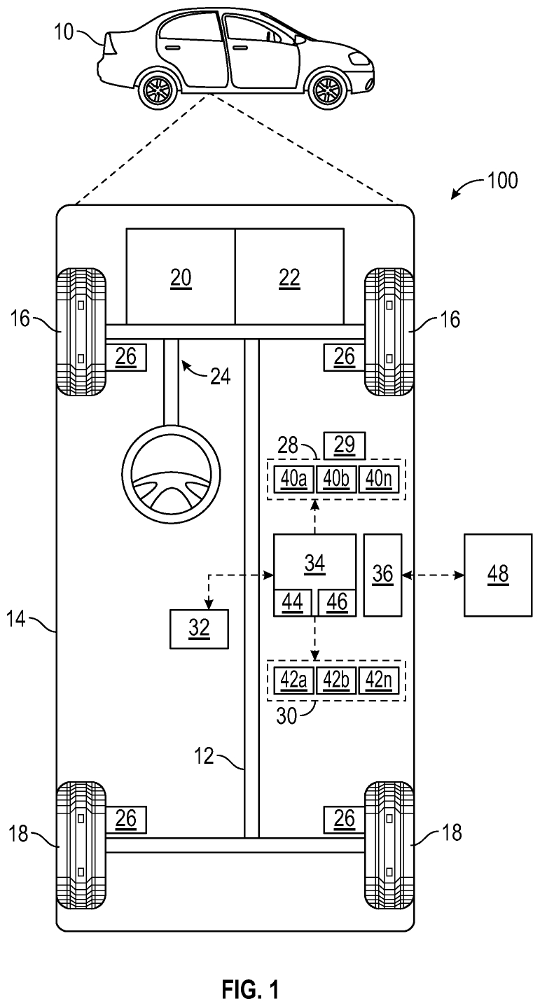

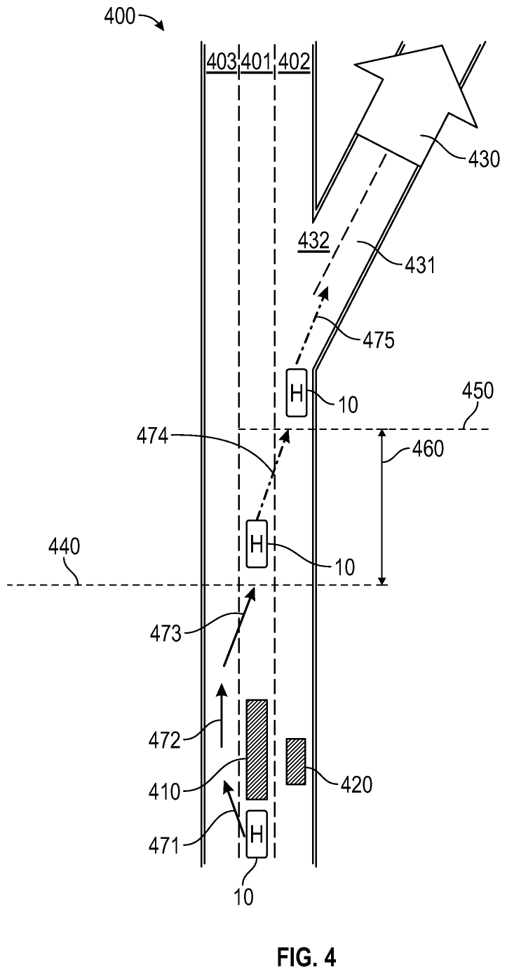

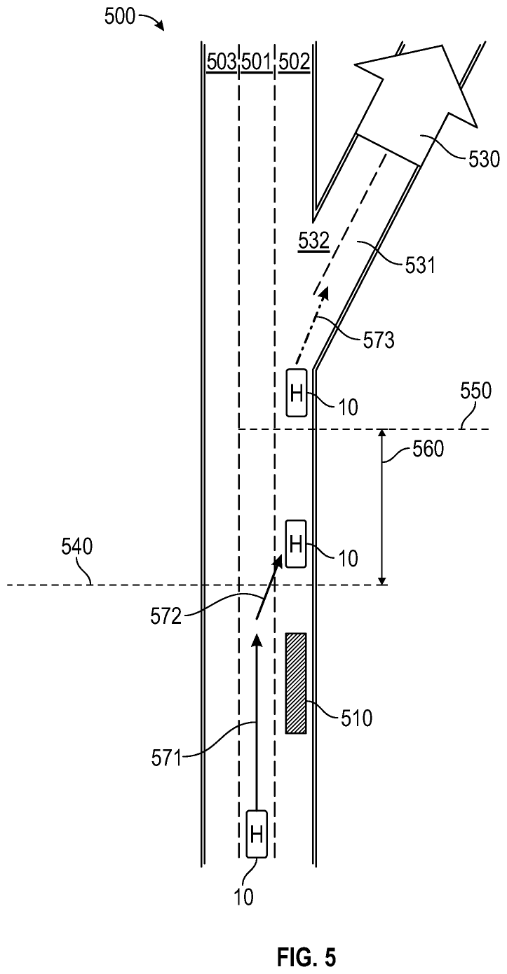

With reference to FIG. 1, a lane change control system shown generally as 100 is associated with a vehicle 10 (also referred to herein as a “host vehicle”) in accordance with various embodiments. In general, the lane change control system (or simply “system”) 100 provides planning for a corridor or path of travel for the vehicle 10 through a roadway that is shared with other vehicles (e.g., which may be referred to as “other vehicles” or “target vehicles” herein), some of which may be blocking the intended path of the vehicle 10 (for example, including in proximity to route splits in the roadway (e.g., in which the vehicle 10 needs to turn onto a different lane or route in order to keep on the intended path to the intended destination), as depicted in FIGS. 4 and 5 and described further below in connection therewith).

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In certain embodiments, the vehicle 10 is an autonomous vehicle, and the lane change control system 100, and/or components thereof, are incorporated into the vehicle 10. The vehicle 10 is, for example, a vehicle that is automatically controlled to carry passengers and/or cargo from one location to another. In certain other embodiments, the vehicle 10 may be a traditional/non-autonomous vehicle, for example controlled and/or driven by a human driver of the vehicle 10. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a lane change system.

As shown, the vehicle 10 generally includes a propulsion system 20, a transmission system 22, a steering system 24, a brake system 26, one or more user input devices 27, a sensor system 28, an actuator system 30, at least one data storage device 32, at least one controller 34, and a communication system 36.

The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

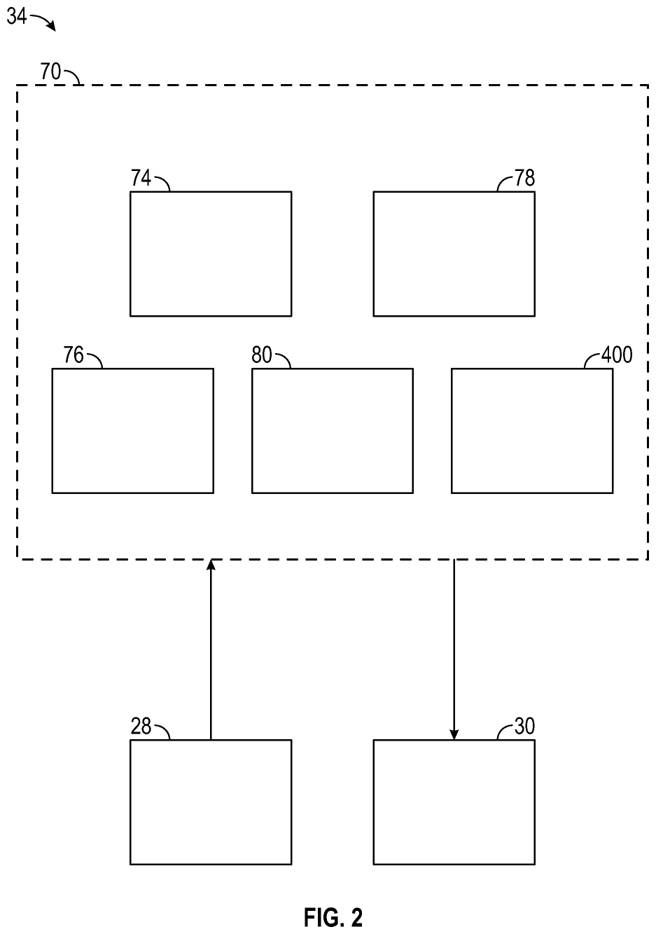

In various embodiments, one or more user input devices 27 receive inputs from one or more passengers of the vehicle 10. In various embodiments, the inputs include a desired destination of travel for the vehicle 10. In certain embodiments, one or more input devices 27 comprise an interactive touch-screen in the vehicle 10. In certain embodiments, one or more input devices 27 comprise a speaker for receiving audio information from the passengers. In certain other embodiments, one or more input devices 27 may comprise one or more other types of devices and/or may be coupled to a user device (e.g., smart phone and/or other electronic device) of the passengers, such as the user device 54 depicted in FIG. 2 and described further below in connection therewith).

The sensor system 28 includes one or more sensors 40a-40n that sense observable conditions of the exterior environment and/or the interior environment of the vehicle 10. The sensors 40a-40n include, but are not limited to, accelerometers, pitch sensors, roll sensors, yaw sensors, radars, lidars, global positioning systems, optical cameras, thermal cameras, ultrasonic sensors, inertial measurement units, and/or other sensors. In various embodiments, some or all of the sensors 40a-40n are part of the above-referenced inertial measurement unit 29 of the vehicle 10.

The actuator system 30 includes one or more actuators 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system. For example, in certain embodiments, the defined maps may be assembled by a remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

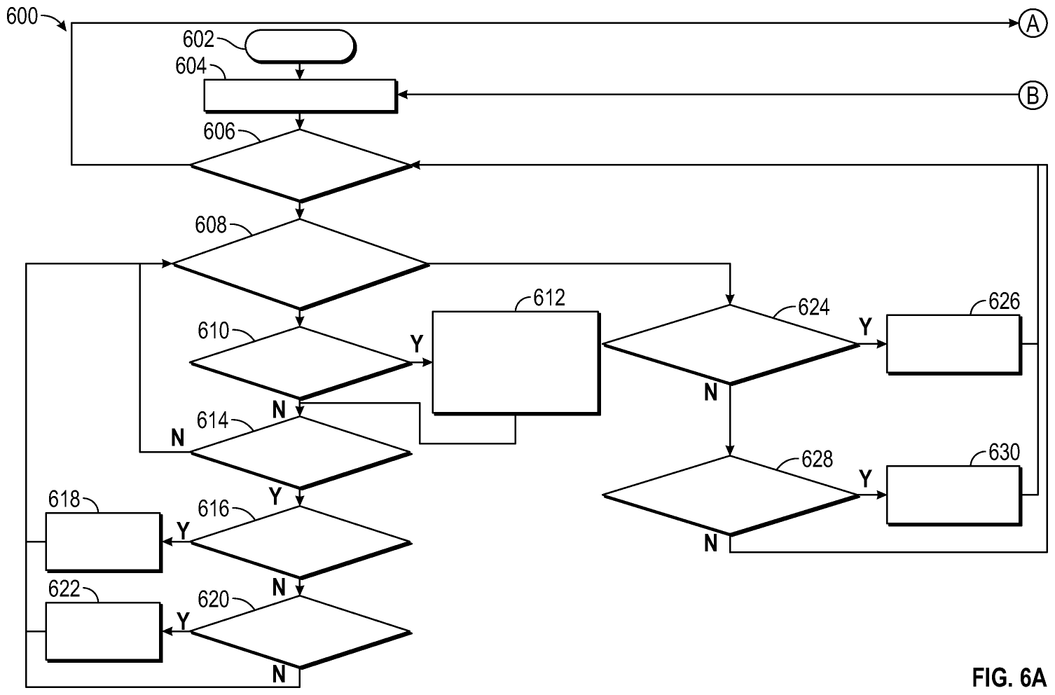

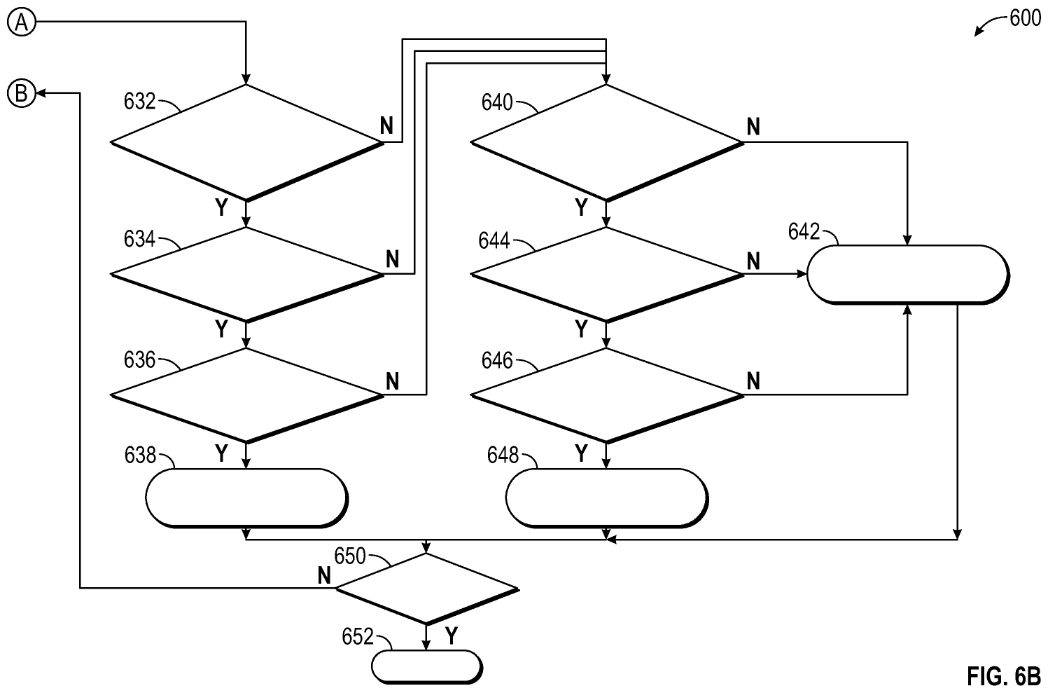

The controller 34 includes at least one processor 44 and a computer-readable storage device 46. In various embodiments, the controller 34 (among various other control features for the vehicle 10 and/or components thereof) provides for lane changes, including arbitration of multiple lane change requests, among various other control functions for the vehicle 10, for example as described in greater detail further below in connection with the process 600 of FIGS. 6A and 6B and described in greater detail further below in connection therewith.

The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media (also referred to herein as computer memory, or memory) 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In certain embodiments, the communication system 36 is configured to wirelessly communicate information to and from other entities 48, such as but not limited to, other vehicles (“V2V” communication), infrastructure (“V2I” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers, and/or one or more sources of remote information (e.g., GPS data, traffic information, weather information, and so on).

In accordance with various embodiments, the controller 34 implements an autonomous driving system (ADS) as shown in FIG. 2. That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, and the like) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, as discussed above with regard to FIG. 1, one or more instructions of the controller 34 are embodied in the lane change control system 100, for controlling lane changes for the vehicle 10, including arbitration of multiple lane change requests. All or parts of the lane change control system 100 may be embodied in the computer vision system 74, and/or the vehicle control system 80 or may be implemented as a separate system.

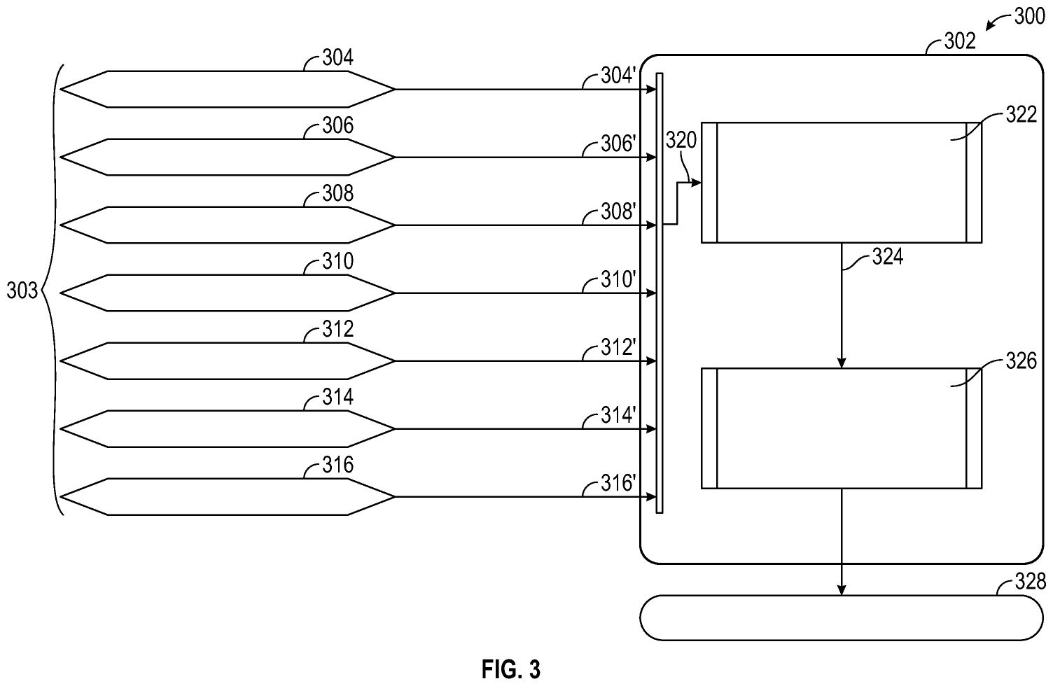

FIG. 3 provides a graphical illustration 300 of the functionality of the lane change control system 100 of FIGS. 1 and 2, in accordance with various embodiments.

As illustrated in FIG. 3, in an exemplary embodiment, the lane change control system 100 utilizes an automated lane change arbitration algorithm (also referred to herein as the “arbitration algorithm”) 302 that arbitrates multiple competing automatic lane change requests to establish natural decision making while following a navigation route through dynamic road and traffic situations, including for lane change maneuvers in proximity to route splits (e.g., in which the vehicle 10 is required to turn into a different road for a different route to keep on the intended path to the intended destination).

Specifically, as depicted in FIG. 3, the arbitration algorithm 302 receives requests from a number of different requestors 303. In various embodiments, the different requestors 303 are part of one or more control systems for the vehicle 10 (including, in various embodiments, the lane change control system 100). In various embodiments, the requestors 303 may include the following, among others: (i) Condition Assessor “0” 304 (e.g., with respect to conditions at a first time, or time “0”); (ii) Condition Assessor “1” 306 (e.g., with respect to conditions at a subsequent time, or time “1”); (iii) Driver Feedback Assessor 308; (iv) Overtaking Condition Assessor 310; (v) Lane Merge Assessor 312; (vi) Route Following Condition Assessor 314; and (vii) any number of additional Condition Assessors M (e.g., with respect to conditions at one or more further subsequent times, or times “2” . . . “M”).

In various embodiments, each of the requestors 303 provides their own respective communications (e.g., communications 304′, 306′, 308′, 310′, 312′, 314′, 316′, and so on) to the lane change control system 100, including the arbitration algorithm 302 of FIG. 3. In various embodiments, these communications include respective priorities of each of the requestors 303 for desired lane change, direction of desired lane change, as well as priority for staying in current lane, and moving in an opposite direction, and so on. Also in various embodiments, each requestor 303 also provides a respective decision distance threshold for each desired (or undesired) maneuver. For example, in certain embodiments, the overtaking condition assessor 310 will provide overtake priorities and distances based on factors such as traffic density, velocity, and the like. By further example, also in certain embodiments, the route following condition assessor 314 provides priorities and distances based on navigation route distances and traffic density attributes, and so on.

In various embodiments, the arbitration algorithm 302 executes real-time prioritization logic to automatically determine optimal route planning and execution thereof for the vehicle 10, including lane changes and overtaking of target vehicles, based on analysis of the communications received from the various requestors 303. In various embodiments, in the case of opposing requests, the arbitration algorithm 302 determines the optimal (i.e., winning) maneuver(s) based on arbitration of the different requests, and thereby further assuring that subsequent required maneuvers can be executed with a reasonable degree of certainty.

As depicted in FIG. 3, in various embodiments, in a first analysis function 322, the arbitration algorithm 302 provides the analysis by first aggregating the various communications from the requestors 303 into an aggregated request compilation 320, and by distilling condition assessments into final positive and negative lane priorities 324 for each lane. Also as depicted in FIG. 3, in various embodiments, in a second analysis function 326, the lane priorities 324 are utilized to determine the final automated lane change command 328, which may then be automatically executed by the vehicle 10 in accordance with the instructions provided by the arbitration algorithm 302.

In various embodiments, the functionality of the lane change control system 100 (including the arbitration algorithm 302 thereof) is explained in greater detail in connection with (i) exemplary implementations provided in FIGS. 4 and 5 of potential lane changes executed by the lane change control system 100; and (ii) a flowchart of a lane change control process implementing the functionality of the lane change control system 100 and the arbitration algorithm 302 thereof.

FIGS. 4 and 5 depict the vehicle 10 of FIG. 1 in connection with exemplary implementations of automated lane change control by the lane change control system 100 and the arbitration algorithm 302 thereof, which include a roadway with traffic impacting potential lane changes for the vehicle, in accordance with various embodiments.

In a first such implementation of FIG. 4, a roadway 400 is depicted in which the vehicle 10 is travelling. In the depicted implementation of FIG. 4, the vehicle 10 is currently moving in a first lane 401 (e.g., a center lane 401 as depicted in FIG. 4). Also in this implementation, a first target vehicle 410 is also disposed in the same center lane 401, and a second target vehicle 420 is disposed in an adjacent lane 402 (e.g., a right lane 402). In various embodiments, the vehicle 10 is planning to take a new route 430 up ahead off to the right, with new lanes 431, 432.

In various embodiments, the vehicle 10 (via the lane change control system 100 and the arbitration algorithm 302 thereof) automatically plans and executes a turn into another adjacent lane 403 (e.g., a left lane 403) in order pass the target vehicle 410 (e.g., when the target vehicle 410 is travelling slower than the vehicle 10), when the passing maneuver is determined to be optimal. As illustrated in FIG. 4, in various embodiments, when the passing maneuver is initiated, the vehicle 10 accomplishes the passing maneuver by taking, in sequence: (i) a first action 411 to turn into the left lane 403; (ii) a second action 412 moving along the left lane 403; and (iii) a third action 413 to turn back into the center lane 401. In addition, regardless of whether the passing maneuver is performed, the vehicle 10 will also need to take additional actions, namely: (iv) a fourth action 414 to turn into the right lane 402; and (v) a fifth action to turn into lane 431 of the new route 430.

In various embodiments, the vehicle 10 determines whether the passing maneuver is optimal based on arbitration of different assessors based at least in part on their respective priorities and associated distances. For example, in the implementation of FIG. 4, such determinations are made based at least on: (i) a first distance (L_{OvrLt}) 440 to overtake the target vehicle 410 and return to the center lane 401; (ii) a second distance (L_{RouteRt}) 450 to reach the new route 430; and (iii) an opportunity window 460 therebetween. In various embodiments, these determinations, along with the associated actions, are executed in connection with the control process 600 depicted in FIGS. 6A and 6B and described further below in connection therewith.

In a second implementation of FIG. 5, a roadway 500 is depicted in which the vehicle 10 is travelling. In the depicted implementation of FIG. 5, the vehicle 10 is currently moving in a first lane 501 (e.g., a center lane 501 as depicted in FIG. 5). Also in this implementation, a target vehicle 510 is disposed in an adjacent lane 502, and a third lane 503 (e.g., a left lane 503) is open. In various embodiments, the vehicle 10 is planning to take a new route 530 up ahead off to the right, with new lanes 531, 532.

In various embodiments, the vehicle 10 (via the lane change control system 100 and the arbitration algorithm 302 thereof) automatically plans and executes an overtake of the target vehicle 510, for example by increasing speed and then turning into the right lane 502 after passing the target vehicle 510, when it is determined that the passing maneuver is optimal. As illustrated in FIG. 5, in various embodiments, when the passing maneuver is initiated, the vehicle 10 accomplishes the passing maneuver by taking, in sequence: (i) a first action 571 within the center lane 501 to overtake the target vehicle 510; and (ii) a second action 572 to turn into the right lane 502 after overtaking the target vehicle 510. In addition, regardless of whether the passing maneuver is performed, the vehicle 10 will also need to take an additional action, namely: (iii) a third action 573 to turn into lane 531 of the new route 530.

In various embodiments, the vehicle 10 determines whether the passing maneuver is optimal based on arbitration of different assessors based at least in part on their respective priorities and associated distances. For example, in the implementation of FIG. 5, such determinations are made based at least on: (i) a first distance (L_{OvrRt}) 540 to overtake the target vehicle 510 and turn into the right lane 502; (ii) a second distance (L_{RouteRt}) 550 to reach the new route 530; and (iii) an opportunity window 560 therebetween. In various embodiments, these determinations, along with the associated actions, are executed in connection with the control process 600 depicted in FIGS. 6A and 6B and described further below in connection therewith.

FIGS. 6A and 6B are flowcharts of a lane change control process in which lane change requests are arbitrated by a lane change control system of a vehicle, and that can be implemented in connection with the vehicle, components, and environments of FIGS. 2-5, in accordance with various embodiments.

With reference to FIGS. 6A and 6B, a flowchart is provided for a control process 600 for controlling lane changes for a vehicle, including arbitration of multiple lane change requests, in accordance with exemplary embodiments. In accordance with various embodiments, the control process 600 can be implemented in connection with the lane change control system 100 and vehicle 10 of FIG. 1, the autonomous driving system of FIG. 2, and the implementations of FIGS. 3-5.

As can be appreciated in light of the disclosure, the order of operation within the control process 600 is not limited to the sequential execution as illustrated in FIG. 6, but may be performed in one or more varying orders as applicable and in accordance with the present disclosure. In various embodiments, the control process 600 can be scheduled to run based on one or more predetermined events, and/or can run continuously during operation of the vehicle 10.

In various embodiments the control process 600 may begin at 602. In various embodiments, process step 602 occurs when an occupant is within the vehicle 10 and the vehicle 10 begins operation in an automated or non-automated manner (e.g., in certain embodiments, when an ignition of the vehicle 10 is turned on or activated).

In various embodiments, during step 604, sensor data is obtained. In various embodiments, sensor data is obtained from the sensors 40a-40n of FIG. 1 (e.g., including sensor data from one or more accelerometers, pitch sensors, roll sensors, yaw sensors, radars, lidars, global positioning systems, optical cameras, thermal cameras, ultrasonic sensors, inertial measurement units, and/or other sensors). In various embodiments, sensor data is obtained continuously throughout the process 600 pertaining to the vehicle 10 itself (including, for example, operational parameters of the vehicle such as position, heading, yaw, torque, velocity, acceleration, and so on) as well as to the roadway on which the vehicle 10 is travelling, including lanes thereof (e.g., including distances to lane curvature or turns required to execute a selected route for the vehicle 10, and so on), and further including target vehicles along the roadway (including, for example, position, heading, yaw, torque, velocity, acceleration, distance from the host vehicle 10, and so on for the target vehicle(s)). In various embodiments, the sensor data is obtained in various iterations of step 604 throughout the process 600.

In various embodiments, condition assessments are provided for each lane on a roadway in which the vehicle is travelling (step 606) and for each condition assessor for each lane (step 608). In various embodiments, the lane change control system 100 of FIG. 1 (including the arbitration algorithm 302 of FIG. 3) receive condition assessments (e.g., including associated requests) from each of the condition assessors of the vehicle 10 (e.g., including each of the requestors 303 of FIG. 3 and for each of the lanes of FIGS. 4 and 5), for example including with respect to potential lane change maneuvers (e.g., including overtaking slower vehicles, and the like).

In various embodiments, there may be any number “N” of lanes under analysis. Also in various embodiments, for every lane, there may be any number “M” of condition assessors. In various embodiments, for a given lane, once it is determined in an iteration of step 608 that the processing of condition assessments (and associated requests) for each of the “M” condition assessors has been performed, the process proceeds to step 624, described further below. Also in various embodiments, once it is determined in an iteration of step 606 that the processing of each of the condition assessments (and/or associated requests) for all “N” of the lanes has been performed, then the process proceeds to step 632 of FIG. 6B, also described further below. Otherwise, while at least some of the condition requests for at least some of the lanes are still being processed, the process instead proceeds to step 610, described directly below.

During step 610, for each particular lane, a determination is made for each condition assessor as to whether a distance requirement “L_m” (e.g., for overtaking a slower vehicle, or the like) for the particular condition assessor is the shortest distance requirement for the particular lane, or “L_shortest” while also being greater than a distance threshold “K_Ln” for the particular lane (n) under analysis. In various embodiments, this is determined by the processor 44 of FIG. 1.

In various embodiments, if it is determined during step 610 that the distance requirement for the particular condition assessor is the shortest distance requirement for the particular lane while also being greater than a distance threshold “K_Ln” for the particular lane (n) under analysis, then the process proceeds to step 612. During step 612, in various embodiments, the “L_shortest” parameter (representing the shortest distance requirement for the particular lane) is updated to be set equal to the distance requirement of the condition assessor currently under analysis (i.e., “L_m”). Also during step 612 in various embodiments, the “P_shortest” parameter (representing the priority of the assessor with the shortest distance for the particular lane) is updated to be set equal to the priority of the condition assessor currently under analysis (i.e., “P_m”), for subsequent use in steps 624 and 628 described further below for comparison with (A) P_Pos_n, representing the maximum priority of assessors with distances less than K_Ln and the one assessor greater than K_Ln with the shortest distance; and (B) P_Neg_n, representing the minimum (or greatest negative value) priority of assessors with distances less than K_Ln and the one assessor greater than K_Ln with the shortest distance, as described further below in connection with steps 624 and 628, respectively. In various embodiments, the “L_shortest” and “P_shortest” parameters are updated by the processor 44 of FIG. 1. In various embodiments, the process then proceeds to step 614, described below.

Conversely, when it is determined during step 610 that the distance requirement for the particular condition assessor is not the shortest distance requirement for the particular lane, then the “L_shortest” and “P_shortest” parameters are not updated, but rather maintain their previous values. In various embodiments, in this situation, the process does not proceed to step 612, but rather proceeds directly to step 614, described directly below.

During step 614, a determination is made as to whether the distance requirement “L_m” for the particular condition assessor “m” is less than the distance threshold “K_Ln” for the particular lane (n) under analysis. In various embodiments, the “K_Ln” value is based on a look-up table, and this determination is made by the processor 44 of FIG. 1 using the look-up table.

In various embodiments, if it is determined during step 614 that the distance requirement “L_m” is greater than or equal to the distance threshold “K_Ln” for the particular lane (n) under analysis, then the process returns to the above-described step 608. In various embodiments, steps 608-614 then repeat until there is a determination in a subsequent iteration of step 614 that the distance requirement “L_m” is less than the distance threshold “K_Ln” for the particular lane (n) under analysis. Once it is determined in an iteration of step 614 that the distance requirement “L_m” is less than the distance threshold “K_Ln” for the particular lane (n) under analysis, the process then proceeds to step 616, described directly below.

During step 616, a determination is made as to whether a priority “P_m” of the condition assessor “m” is greater than a current positive arbitration ranking score “P_pos_n” for the lane “n”. In various embodiments, this determination is made by the processor 44 of FIG. 1.

In various embodiments, if it is determined during step 616 that the priority “P_m” of the condition assessor “m” is greater than the current positive arbitration ranking score “P_pos_n” for the lane “n”, then the current positive arbitration ranking score “P_pos_n” for the lane “n” is set equal to the priority “P_m” of the condition assessor “m” (step 618). In various embodiments, this is performed by the processor 44 of FIG. 1. Also in various embodiments, the process then returns to step 608, and steps 608-618 repeat in this manner in new iterations until a determination is made in an iteration of step 616 that the priority

“P_m” of the condition assessor “m” is less than or equal to the current positive arbitration ranking score “P_pos_n” for the lane “n”. In various embodiments, once it is determined in an iteration of step 616 that the priority “P_m” of the condition assessor “m” is less than or equal to the current positive arbitration ranking score “P_pos_n” for the lane “n”, then the process proceeds to step 620, described directly below.

During step 620, a determination is made as to whether a priority “P_m” of the condition assessor “m” is less than or equal to a current negative arbitration ranking score “P_neg_n” for the lane “n”. In various embodiments, this determination is made by the processor 44 of FIG. 1.

In various embodiments, during steps 616-620, and in certain embodiments elsewhere throughout the process 600, the positive and negative arbitration scores are updated by the processor 144 of FIG. 1 based on highest positive and negative priorities for the lanes, based upon comparison of required distances for the lanes with a predetermined threshold.

In various embodiments, if it is determined during step 620 that the priority “P_m” of the condition assessor “m” is less than the current negative arbitration ranking score “P_neg_n” for the lane “n”, then the current negative arbitration ranking score “P_neg_n” for the lane “n” is set equal to the priority “P_m” of the condition assessor “m” (step 622). In various embodiments, this is performed by the processor 44 of FIG. 1. Also in various embodiments, the process then returns to step 608, and steps 608-622 repeat in this manner in new iterations until a determination is made in an iteration of step 620 that the priority “P_m” of the condition assessor “m” is greater than or equal to the current negative arbitration ranking score “P_neg_n” for the lane “n”. In various embodiments, once it is determined in an iteration of step 620 that the priority “P_m” of the condition assessor “m” is greater than or equal to the current negative arbitration ranking score “P_neg_n” for the lane “n”, then the process proceeds to step 608, and steps 608-622 thereafter repeat in new iterations with different condition assessors “m” until each of the condition assessors “m” have been performed for the particular lane “n”, at which point the process proceeds to step 624, described below.

During step 624, in various embodiments after each of the condition assessors “m” have been analyzed for a particular lane ‘n″, a determination is made as to whether the “P_shortest” parameter is greater than the current positive arbitration ranking score “P_pos_n” for the lane “n”. In various embodiments, this determination is made by the processor 144 of FIG. 1.

In various embodiments if it is determined during step 624 that the “P_shortest” parameter is greater than the current positive arbitration ranking score “P_pos_n” for the lane “n”, then the process proceeds to step 626. During step 626, in various embodiments, the current positive arbitration ranking score “P_pos_n” for the lane is set equal to the P_shortest” parameter. In various embodiments, this is performed by the processor 144 of FIG. 1. Also in various embodiments, the process then proceeds to step 606 in a new iteration for a new lane under analysis, and steps 606-626 thereafter repeat in new iteration for the new lane under analysis until a determination is made during an iteration of step 624 that the “P_shortest” parameter is less than or equal to the current positive arbitration ranking score “P_pos_n” for the lane “n”. In various embodiments, once it is determined in an iteration of step 624 that the “P_shortest” parameter is less than or equal to the current positive arbitration ranking score “P_pos_n” for the lane “n”, then the process proceeds to step 628, described directly below.

During step 628, a determination is made as to whether the “P_shortest” parameter is less than the current negative arbitration ranking score “P_neg_n” for the lane “n”. In various embodiments, this determination is made by the processor 144 of FIG. 1.

In various embodiments if it is determined during step 628 that the “P_shortest” parameter is less than the current negative arbitration ranking score “P_neg_n” for the lane “n”, then the process proceeds to step 630. During step 630, in various embodiments, the current negative arbitration ranking score “P_neg_n” for the lane is set equal to the P_shortest” parameter. In various embodiments, this is performed by the processor 144 of FIG. 1. Also in various embodiments, the process then proceeds to step 606 in a new iteration for a new lane under analysis, and steps 606-630 thereafter repeat in new iteration for the new lane under analysis until a determination is made during an iteration of step 628 that the “P_shortest” parameter is greater than or equal to the current negative arbitration ranking score “P_neg_n” for the lane “n”. In various embodiments, once it is determined in an iteration of step 628 that the “P_shortest” parameter is greater than or equal to the current negative arbitration ranking score “P_neg_n” for the lane “n”, then the process proceeds likewise returns to step 606.

As noted above in various embodiments, once it is determined in an iteration of step 606 that the processing of each of the condition assessments (and/or associated requests) for all “N” of the lanes has been performed, then the process proceeds to step 632 of FIG. 6B, as described directly below. As described in greater detail below, steps 632-652 (beginning with step 632) determines whether one or more automatic lane changes are appropriate based on respective sizes of positive and negative arbitration ranking scores for various lanes on a roadway in which the vehicle 10 is travelling, including: (i) a “current lane” in which the vehicle 10 is currently travelling; (ii) a “right lane” adjacent and to the right of the vehicle 10 (from the perspective of an occupant of the vehicle 10); and (iii) a “left lane” adjacent and to the left of the vehicle 10 (from the perspective of an occupant of the vehicle 10).

During step 632, in various embodiments, a determination is made as to whether a final positive arbitration ranking score for the left lane “P_{PosLt}” is greater than a final absolute value of a negative arbitration ranking score for the left lane, namely “abs(P_{NegLt})”. In various embodiments, this determination is made by the processor 144 of FIG. 1.

In various embodiments, if it is determined during step 632 that the final positive arbitration ranking score for the left lane “P_{PosLT}” is less than or equal to the final absolute value of the negative arbitration ranking score for the left lane “abs(P_{NegLt})”, then the process proceeds to step 640, described further below. Conversely, if it is instead determined during step 632 that the final positive arbitration ranking score for the left lane “P_{PosLt}” is greater than the final absolute value of the negative arbitration ranking score for the left lane “abs(P_{NegLt})”, then the process proceeds instead to step 634, described directly below.

During step 634, in various embodiments, a determination is made as to whether the final positive arbitration ranking score for the left lane “P_{PosLT}” is greater than a final positive arbitration ranking score for the right lane “P_{PosRt}”. In various embodiments, this determination is made by the processor 144 of FIG. 1.

In various embodiments, if it is determined during step 634 that the final positive arbitration ranking score for the left lane “P_{PosLt}” is less than or equal to the final positive arbitration ranking score for the right lane “P_{PosRt}”, then the process proceeds to step 640, described further below. Conversely, if it is instead determined during step 634 that the final positive arbitration ranking score for the left lane “P_{PosLt}” is greater than the final positive arbitration ranking score for the right lane “P_{PosRt}”, then the process proceeds instead to step 636, described directly below.

During step 636, in various embodiments, a determination is made as to whether the final positive arbitration ranking score for the left lane “P_{PosLt}” is greater than a final positive arbitration ranking score for the current lane “P_{PosCurr}” in which the vehicle 10 is travelling. In various embodiments, this determination is made by the processor 144 of FIG. 1.

In various embodiments, if it is determined during step 636 that the final positive arbitration ranking score for the left lane “P_{PosLt}” is less than or equal to the final positive arbitration ranking score for the current lane “P_{PosCurr}”, then the process proceeds to step 640, described further below. Conversely, if it is instead determined during step 636 that the final positive arbitration ranking score for the left lane “P_{PosLt}” is greater than the final positive arbitration ranking score for the current lane “P_{PosCurr}”, then the process proceeds instead to step 638, described directly below.

During step 638, in various embodiments, a command is provided for the vehicle to automatically change lanes into the left lane (e.g., the lane immediately to the left of the vehicle 10 based on the perspective of a forward-facing occupant of the vehicle 10). In various embodiments, this command is made by the processor 144 of FIG. 1 and is executed by steering system 24 of FIG. 1 in accordance with instructions received from the processor 144. In certain embodiments, the lane change maneuver may also be executed in part by the propulsion system 20, brake system 26, and/or other systems of the vehicle 10, for example in speeding up and/or slowing down as part of passing a target vehicle in the process of making the lane change, and so on.

In various embodiments, the process then proceeds to step 650, and a determination is made as to whether any other lane maneuvers are required, for example in order for the vehicle 10 to remain on its route of travel and/or to pass any other slow moving target vehicles, and so on. In certain embodiments, this determination is made by the processor 144 of FIG. 1. In various embodiments, if it is determined during step 650 that one or more additional lane maneuvers are required, then the process then proceeds to the above-described step 604, as additional sensor data continues to be collected. Conversely, if it is instead determined during step 650 that no additional lane maneuvers are required, then the process terminates at step 652.

With reference back to steps 632-636, as noted above, in various embodiments when the final positive arbitration ranking score for the left lane “P_{PosLt}” is less than or equal to any of the negative arbitration ranking score for the left lane “abs(P_{NegLt})”, the final positive arbitration ranking score for the right lane “P_{PosRt}”, or the final positive arbitration ranking score for the current lane “P_{PosCurr}”, the proceed proceeds to step 640, which will be described directly below.

During step 640, in various embodiments, a determination is made as to whether a final positive arbitration ranking score for the right lane “P_{PosRt}” is greater than a final absolute value of a negative arbitration ranking score for the right lane, namely “abs(P_{NegRt})”. In various embodiments, this determination is made by the processor 144 of FIG. 1.

In various embodiments, if it is determined during step 640 that the final positive arbitration ranking score for the right lane “P_{PosRt}” is less than or equal to the final absolute value of the negative arbitration ranking score for the right lane “abs(P_{NegRt})”, then the process proceeds to step 642, described further below. Conversely, if it is instead determined during step 640 that the final positive arbitration ranking score for the right lane “P_{posRt}” is greater than the final absolute value of the negative arbitration ranking score for the right lane “abs(P_{NegRt})”, then the process proceeds instead to step 644, described directly below.

During step 644, in various embodiments, a determination is made as to whether the final positive arbitration ranking score for the right lane “P_{PosRt}” is greater than a final positive arbitration ranking score for the left lane “P_{PosLt}”. In various embodiments, this determination is made by the processor 144 of FIG. 1.

In various embodiments, if it is determined during step 644 that the final positive arbitration ranking score for the right lane “P_{PosRt}” is less than or equal to the final positive arbitration ranking score for the left lane “P_{PosLt}”, then the process proceeds to step 642, described further below. Conversely, if it is instead determined during step 644 that the final positive arbitration ranking score for the right lane “P_{PosRt}” is greater than the final positive arbitration ranking score for the left lane “P_{PosLt}”, then the process proceeds instead to step 646, described directly below.

During step 646, in various embodiments, a determination is made as to whether the final positive arbitration ranking score for the right lane “P_{PosRt}” is greater than a final positive arbitration ranking score for the current lane “P_{PosCurr}” in which the vehicle 10 is travelling. In various embodiments, this determination is made by the processor 144 of FIG. 1.

In various embodiments, if it is determined during step 646 that the final positive arbitration ranking score for the right lane “P_{PosRt}” is less than or equal to the final positive arbitration ranking score for the current lane “P_{PosCurr}”, then the process proceeds to step 642, described further below. Conversely, if it is instead determined during step 646 that the final positive arbitration ranking score for the right lane “P_{PosRt}” is greater than the final positive arbitration ranking score for the current lane “P_{PosCurr}”, then the process proceeds instead to step 648, described directly below.

During step 648, in various embodiments, a command is provided for the vehicle to automatically change lanes into the right lane (e.g., the lane immediately to the right of the vehicle 10 based on the perspective of a forward-facing occupant of the vehicle 10). In various embodiments, this command is made by the processor 144 of FIG. 1 and is executed by steering system 24 of FIG. 1 in accordance with instructions received from the processor 144. In certain embodiments, the lane change maneuver may also be executed in part by the propulsion system 20, brake system 26, and/or other systems of the vehicle 10, for example in speeding up and/or slowing down as part of passing a target vehicle in the process of making the lane change, and so on.

In various embodiments, the process then proceeds to the above-described step 650, in which a determination is made as to whether any other lane maneuvers are required. As described earlier in greater detail, in various embodiments if it is determined during step 650 that one or more additional lane maneuvers are required then the process then proceeds to the above-described step 604—otherwise, then the process terminates at step 652.

With reference back to steps 640-646, as noted above, in various embodiments when the final positive arbitration ranking score for the right lane “P_{PosRt}” is less than or equal to any of the negative arbitration ranking score for the right lane “abs(P_{NegRt})”, the final positive arbitration ranking score for the left lane “P_{PosLt}”, or the final positive arbitration ranking score for the current lane “P_{PosCurr}”, the proceed proceeds to step 642, which will be described directly below.

During step 642, in various embodiments, no lane change is commanded. Specifically, in various embodiments, the vehicle 10 remains in its current lane, in accordance with instructions provided by the processor 144 of FIG. 1.

In various embodiments, the process then proceeds to the above-described step 650, in which a determination is made as to whether any other lane maneuvers are required. As described earlier in greater detail, in various embodiments if it is determined during step 650 that one or more additional lane maneuvers are required then the process then proceeds to the above-described step 604—otherwise, then the process terminates at step 652.

It will be appreciated that in various embodiments the process 600 of FIGS. 6A and 6B may be implemented in connection with the scenarios depicted in FIGS. 4 and 5 and described above in connection therewith, among various other different types of lane change maneuvers and scenarios.

For example, with respect to the first scenario described above in connection with FIG. 4, the host vehicle 10 in the center lane 401 has the opportunity to pass slower target vehicles 410, 420 in the same center lane 401 and in the right lane 402, by the host vehicle 10 first turning into the left lane 403, and subsequently returning to the center lane 401 and ultimately turning into the right lane 402 (after passing the target vehicles 410, 420) toward the new route 430 of FIG. 4.

In a simplified illustration of this first scenario of FIG. 4, it is assumed that only the overtaking condition assessor 310 and route following condition assessor 314 of FIG. 3 are active. In this exemplary illustration, the overtaking condition assessor 310 requests a lane change to the left lane 403 to pass the slower moving target vehicle 410 by setting a positive rating for the left lane 403 and a negative priority for the current lane (i.e., center lane) 401 and at the same time predicts the distance required to execute the overtake and return. Also in this exemplary illustration, the route following condition assessor 314 sets the left lane 403 and current lane (i.e., center lane) 401 ratings negative and the right lane 402 rating positive while also calculating the distance required for the first lane change right. If the overtaking distance is shorter than the route requirement distance, the overtake priority shall be accepted and the lane change left commanded.

In various embodiments, the decision to implement the lane change maneuver in this exemplary illustration of FIG. 4 is made by the processor 144 of FIG. 1 utilizing the above-described steps of the process 600 of FIGS. 6A and 6B in accordance with the discussion above, and utilizing the following equations:

L_{OverLt}=K_{G}*(V_{Curr}*t_{AvgALC}+V_{LtExp}*t_{EstOvr}+V_{LtExp}*t_{AvgALC})+K_{A} (Equation 1);

V_{LtExp}=min(V_{LtAvgObs}, V_{Set}) (Equation 2);

t_{EstOvr}=(L_{XCIP}+L_{enCIP}+Kᵣ)/V_{EstOvr} (Equation 3);

V_{EstOvr}=V_{LtExp}−V_{CIP} (Equation 4);

L_{RouteRt}=(K_{G}*L_{Split})/(N_{Lane}*t_{AvgALC}*V_{Curr}) (Equation 5);

P_{OvrLt}=K_{Lookup}(_{VxCIP}, L_{XCIP}, V_{xLtObj}, L_{xLtObj}) (Equation 6); and

P_{RouteRt}=K_{Lookup}(L_{Split}) (Equation 7);

in which:

“L_{OverLt}” represents the predicted distance required to overtake the closest in path vehicle (“CIP”);

“K_{G}” represents a tolerance gain;

“V_{Curr}” represents the current measured velocity of the host vehicle;

“t_{AvgALC}” represents the average time to complete the automated lane change (“ALC”);

“V_{LtExp}” represents the expected lane velocity of the host vehicle after the overtaking ALC;

“t_{EstOvr}” represents the estimated time to overtake the CIP;

“K_{A}” represents a tolerance addition;

“V_{LtAvgObs}” represents the average speed of the traffic in the left lane;

“V_{Set}” represents the driver's selected set speed;

“L_{XCIP}” represents the longitudinal distance to the CIP;

“L_{enCIP}” represents the longitudinal length of the CIP; and

“Kᵣ” represents the distance between the rear of the host and the front of the right rear target.

By way of additional example, with respect to the second scenario described above in connection with FIG. 5, the host vehicle 10 in the center lane 501 has the opportunity to pass the slower target vehicle 510 in the right lane 502, by the host vehicle 10 first speeding up in the center lane 501 and subsequently turning into the right lane 502 and travelling through the right lane 502 toward the new route 530 of FIG. 5.

In a simplified illustration of this second scenario of FIG. 5, it is likewise assumed that only the overtaking condition assessor 310 and route following condition assessor 314 of FIG. 3 are active. In this exemplary illustration, the route following condition assessor 314 of FIG. 3 requests a lane change right by providing a positive rating for the right lane 502 and a negative rating for the current lane (i.e., center lane 501) of FIG. 5. Also in this exemplary illustration, the overtaking condition assessor 310 of FIG. 3 creates a negative rating for the right lane 502. In various embodiments, if the overtake distance is less than the route distance, the automatic lane change to the right lane 502 will be blocked. Also in various embodiments, if the route distance is less than the overtake distance, the automatic lane change to the right lane 502 will be executed.

In various embodiments, the decision to implement the lane change maneuver in this exemplary illustration of FIG. 5 is made by the processor 144 of FIG. 1 utilizing the above-described steps of the process 600 of FIGS. 6A and 6B in accordance with the discussion above, and utilizing the following equations:

L_{OverRt}=K_{G}*V_{Curr}(*t_{AvgALC}+t_{EstOvr})+K_{A} (Equation 8);

t_{EstOvr}=(L_{XRt}+L_{enRr}+Kᵣ)/−V_{xRt} (Equation 9);

L_{RouteRt}=(K_{G}*L_{Split})/(N_{Lane}*t_{AvgALC}*V_{Curr}) (Equation 10);

P_{OvrRt}=K_{Lookup}(V_{xRtObj}, L_{xRtObj}) (Equation 11); and

P_{RouteRt}=K_{Lookup}(L_{Split}) (Equation 12);

in which:

“L_{OverRt}” represents the predicted distance required to overtake the right lane target;

“t_{EstOvr}” represents the estimated time to overtake the right lane target; and

“VXRt” represents the relative velocity of the right lane target with respect to the host vehicle.

Accordingly, in various embodiments, methods, systems, and vehicles are provided that provide for automatic lane change control for the vehicles based on arbitration of requests provided by a plurality of different condition assessors each for a plurality of different lanes along a roadway in which the vehicle 10 is travelling while following a navigation route through dynamic road and traffic situations. In various embodiments, the arbitration of the various requests provided by the various condition assessors is performed using an automated lane change arbitration algorithm based on respective priorities of requestor utilizing required distance thresholds for each lane change maneuver, and by calculating and comparing positive and negative arbitration scores for each of the lanes on the roadway in which the vehicle 10 is travelling.

It will be appreciated that, in various embodiments, the vehicles, systems, and components depicted in the drawings and described above may vary. It will similarly be appreciated that the steps, implementations, and examples depicted in the drawings and described above may also vary, and/or may be performed in a different order or sequence, and so on.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for automatically controlling lane changes for a vehicle, the method comprising:
obtaining sensor data via one or more vehicle sensors during operation of the vehicle, the sensor data pertaining to operation of the vehicle and surroundings of the vehicle along a roadway in which the vehicle is travelling;
receiving, from a plurality of vehicle assessors, a plurality of respective requests with respect to one or more automated lane change maneuvers for the vehicle; and
selectively implementing the one or more automated lane change maneuvers for the vehicle, in accordance with instructions provided by a processor of the vehicle, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

2. The method of claim 1, wherein the one or more automated lane change maneuvers comprise a passing of one or more target vehicles along the roadway, and the plurality of vehicle assessors includes an overtaking condition assessor configured to make one or more requests pertaining to passing of the one or more target vehicles along the roadway.

3. The method of claim 2, wherein the plurality of vehicle assessors further includes a route following condition assessor configured to make one or more additional requests pertaining to following a route of travel for the vehicle.

4. The method of claim 1, wherein the lane arbitration scores are based upon a shortest distance required for each of the one or more automated lane change maneuvers.

5. The method of claim 1, wherein the lane arbitration scores include positive and negative arbitration scores for the plurality of lanes, wherein a positive arbitration score for a particular lane of the plurality of lanes indicates that turning into the particular lane is optimal, and wherein a negative arbitration score for the particular lane indicates that turning into the particular lane is not optimal.

6. The method of claim 1, wherein the positive and negative arbitration scores are updated by the processor based on highest positive and negative priorities for the plurality of lanes, based upon comparison of required distances for the plurality of lanes with a predetermined threshold.

7. The method of claim 1, wherein the steps of the method are implemented in connection with an autonomous vehicle.

8. A system for automatically controlling lane changes for a vehicle, the system comprising:
one or more vehicle sensors configured to provide sensor data during operation of the vehicle, the sensor data pertaining to operation of the vehicle and surroundings of the vehicle along a roadway in which the vehicle is travelling; and
a processor coupled to the one or more vehicle sensors and configured to at least facilitate:
receiving, from a plurality of vehicle assessors, a plurality of respective requests with respect to one or more automated lane change maneuvers for the vehicle; and
selectively implementing the one or more automated lane change maneuvers for the vehicle, in accordance with instructions provided by the processor, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

9. The system of claim 8, wherein the one or more automated lane change maneuvers comprise a passing of one or more target vehicles along the roadway, and the plurality of vehicle assessors includes an overtaking condition assessor configured to make one or more requests pertaining to passing of the one or more target vehicles along the roadway.

10. The system of claim 9, wherein the plurality of vehicle assessors further includes a route following condition assessor configured to make one or more additional requests pertaining to following a route of travel for the vehicle.

11. The system of claim 8, wherein the lane arbitration scores are based upon a shortest distance required for each of the one or more automated lane change maneuvers.

12. The system of claim 8, wherein the lane arbitration scores include positive and negative arbitration scores for the plurality of lanes, wherein a positive arbitration score for a particular lane of the plurality of lanes indicates that turning into the particular lane is optimal, and wherein a negative arbitration score for the particular lane indicates that turning into the particular lane is not optimal.

13. The system of claim 8, wherein the positive and negative arbitration scores are updated by the processor based on highest positive and negative priorities for the plurality of lanes, based upon comparison of required distances for the plurality of lanes with a predetermined threshold.

14. A vehicle comprising:
one or more vehicle sensors configured to provide sensor data during operation of the vehicle, the sensor data pertaining to operation of the vehicle and surroundings of the vehicle along a roadway in which the vehicle is travelling;
a control system including a plurality of vehicle assessors; and
a processor coupled to the one or more vehicle sensors and to the plurality of vehicle assessors and configured to at least facilitate:
receiving, from the plurality of vehicle assessors, a plurality of respective requests with respect to one or more automated lane change maneuvers for the vehicle; and
selectively implementing the one or more automated lane change maneuvers for the vehicle, in accordance with instructions provided by the processor, based on an arbitration algorithm that is executed by the processor and that provides arbitration for the plurality of respective requests from the plurality of vehicle assessors utilizing respective lane arbitration scores for a plurality of lanes of the roadway pertaining to the one or more automated lane change maneuvers.

15. The vehicle of claim 14, wherein the one or more automated lane change maneuvers comprise a passing of one or more target vehicles along the roadway, and the plurality of vehicle assessors includes an overtaking condition assessor configured to make one or more requests pertaining to passing of the one or more target vehicles along the roadway.

16. The vehicle of claim 15, wherein the plurality of vehicle assessors further includes a route following condition assessor configured to make one or more additional requests pertaining to following a route of travel for the vehicle.

17. The vehicle of claim 14, wherein the lane arbitration scores are based upon a shortest distance required for each of the one or more automated lane change maneuvers.

18. The vehicle of claim 14, wherein the lane arbitration scores include positive and negative arbitration scores for the plurality of lanes, wherein a positive arbitration score for a particular lane indicates that turning into the particular lane is optimal, and wherein a negative arbitration score for the particular lane indicates that turning into the particular lane is not optimal.

19. The vehicle of claim 14, wherein the positive and negative arbitration scores are updated by the processor based on highest positive and negative priorities for the plurality of lanes, based upon comparison of required distances for the lanes with a predetermined threshold.

20. The vehicle of claim 14, wherein the vehicle comprises an autonomous vehicle.
